(19) United States
(12) Patent Application Publication
(10) Pub. No.: US 2006/0233540 A1
(43) Pub. Date: Oct. 19, 2006

(54) Optical finder

(75) Inventor: Naoki Motobayashi, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/405,483

(22) Filed: Apr. 18, 2006

(30) Foreign Application Priority Data
Apr. 19, 2005 (JP) 2005-121644

(51) Int. Cl. G03B 17/00

(52) U.S. Cl. 396/84

(57) ABSTRACT

An optical finder having a variable field of view that changes in synchronization with zooming of an imaging lens includes a tubular finder housing having opening portions on an objective side thereof and an opening portion on an eyepiece side thereof and a field of view limiting member for limiting an aperture corresponding to the field of view from the opening portion on the eyepiece side by protruding from an inner face of the finder housing. The field of view corresponding to the aperture is increased or decreased in synchronization with zooming of the imaging lens. The field of view limiting member includes four aperture limiting members that are pressed inward from upper, lower, left, and right inner faces of the finder housing and aperture adjusting members having oblique side portions that are sandwiched between a pair of the upper and the lower aperture limiting members and between a pair of the left and the right aperture limiting members respectively.

This application is based on Japanese Patent Application No. 2005-121644 filed on Apr. 19, 2005, the contents of which are hereby incorporated by reference.

### BACKGROUND OF THE INVENTION

1. Field of the Invention

The present invention relates to an optical finder of a camera having a zooming function. In particular, it relates to an optical finder having a variable field of view that changes in synchronization with zooming.

2. Description of Related Art

For a camera having a zooming function, one of structures for changing a field of view of an optical finder in synchronization with zooming is a zoom mechanism including a plurality of moving lenses provided in an optical finder unit. A cam mechanism is used for driving the moving lenses of the optical finder unit in synchronization with zooming of imaging lenses. In this way, the field of view of the optical finder changes.

FIG. 5 shows a structure of a conventional optical finder unit described above. As shown in FIG. 5, this optical finder unit 1 includes a tubular finder housing 2 having opening portions on the front side, i.e., an objective side of the camera and the rear side, i.e., an eyepiece side, and a finder optical system 3 housed in the finder housing 2.

This finder optical system 3 includes an objective lens 4 disposed at an opening portion 2a on the objective side of the finder housing 2 and an eyepiece lens 5 (not shown) disposed at an opening portion 2b on the eyepiece side of the finder housing 2. Along an optical axis L shown by a dashed dotted line between the objective lens 4 and the eyepiece lens 5, there are arranged the objective lens 4, a first moving lens 6, a second moving lens 7, a condenser lens 8, and prisms 9 and 10 in this order.

The first moving lens 6 and the second moving lens 7 are provided with follower pins 6a and 7a, respectively, each of which protrudes downward diagonally. These follower pins engage a cam (not shown), provided to a barrel of an imaging lens, for zooming the finder. Through the cam, the first moving lens 6 and the second moving lens 7 move along the optical axis L between the objective lens 4 and the condenser lens 8 while changing a distance between them in synchronization with zooming of the imaging lens.

FIGS. 6A-7B show a structure of the conventional optical finder unit described above. FIGS. 6A and 6B show the state of tele end, while FIGS. 7A and 7B show the state of wide end. Furthermore, FIGS. 6A and 7A are cross sections viewed from top, while FIGS. 6B and 7B are side elevation views. As shown in FIGS. 6A-7B, the first moving lens 6 and the second moving lens 7 move in a reciprocating manner between a tele end position and a wide end position along the optical axis L, so that an adjustment (zooming) of a field of view of the optical finder is performed.

Concerning another conventional technique, JP-A-2002-6370 discloses a camera that can change a field of view of an optical finder in response to switching of an imaging screen. Another patent publication JP-A-11-24133 discloses a mechanism for switching a field of view of an optical finder that can be housed within a space smaller than the conventional one regardless of its state so that a small size of an optical finder unit and a camera can be realized. JP-A-09-211549 discloses an optical finder having a variable field of view that can achieve a stable operation with little malfunction in switching the field of view of the optical finder.

However, since the conventional optical finder unit shown in FIGS. 5-7B has an optical system made up of a plurality of lenses and prisms combined with each other, it has a disadvantage in that the structure of the optical finder unit becomes complicated. This disadvantage may cause increase of cost and may become a factor of troubles in manufacture or use. In addition, the structures disclosed in the above-mentioned patent publications are for supporting switching between formats about a print area for printing imaging information or the like. They are not related directly to changing a field of view of an optical finder in synchronization with zooming of an imaging lens.

### SUMMARY OF THE INVENTION

An object of the present invention is to provide an optical finder capable of adjusting a field of view of an optical finder in synchronization with zooming of an imaging lens by a simple configuration without using an expensive optical component such as a lens or a prism.

An optical finder according to the present invention is an optical finder of a camera having a variable field of view that changes in synchronization with zooming of an imaging lens. The optical finder includes a tubular finder housing having opening portions on an objective side thereof and an opening portion on an eyepiece side thereof, and a field of view limiting member for limiting an aperture corresponding to the field of view from the opening portion on the eyepiece side by protruding from an inner face of the finder housing, so that the field of view corresponding to the aperture is increased or decreased in synchronization with zooming of the imaging lens.

According to this structure, the field of view of the optical finder can be changed in synchronization with zooming of the imaging lens by a simple configuration without using an expensive optical component such as a lens or a prism.

In a preferable embodiment, the field of view limiting member is a plate with an aperture arranged in a center portion thereof for determining the field of view, and the plate moves along an optical axis in synchronization with zooming of the imaging lens so that the field of view corresponding to the aperture is increased or decreased.

In another preferable embodiment, the field of view limiting member comprises four aperture limiting members that are pressed inward from upper, lower, left, and right inner faces of the finder housing and aperture adjusting members having oblique side portions that are sandwiched between a pair of the upper and the lower aperture limiting members and between a pair of the left and the right aperture limiting members respectively, and the aperture adjusting members are moved along an optical axis in synchronization with zooming of the imaging lens so that the field of view is increased or decreased corresponding to a width of the aperture between the pair of the upper and the lower aperture limiting members and a width of the aperture between the pair of the left and the right aperture limiting members.

In still another preferable embodiment, the field of view limiting member comprises four door members that are rotationally pivoted around rotational axes on left, right, upper, and lower inner surfaces of the finder housing respectively, and the four door members rotate in synchronization with zooming of the imaging lens so that the field of view is increased or decreased corresponding to a width of the aperture between the pair of the upper and the lower door members and a width of the aperture between the pair of the left and the right door members.

### BRIEF DESCRIPTION OF THE DRAWINGS

FIG. 1A is a cross section viewed from top showing schematically a structure of an optical finder unit according to a first example of the present invention;

FIG. 1B is a front elevation view showing schematically the structure of the optical finder unit according to the first example;

FIG. 2A is a cross section viewed from top showing schematically a structure of an optical finder unit according to a second example of the present invention;

FIG. 2B is a front elevation view showing schematically the structure of the optical finder unit according to the second example;

FIG. 2C is a cross section viewed from side showing schematically the structure of the optical finder unit according to the second example;

FIG. 3 is a perspective view showing schematically an example of a concrete structure of the optical finder unit according to the second example;

FIG. 4A is a cross section viewed from top showing schematically a structure of an optical finder unit according to a third example of the present invention;

FIG. 4B is a front elevation view showing schematically the structure of the optical finder unit according to the third example;

FIG. 4C is a cross section viewed from side showing schematically the structure of the optical finder unit according to the third example;

FIG. 5 is a perspective view showing a structure of a conventional optical finder unit;

FIG. 6A is a cross section viewed from top showing a state of tele end of the conventional optical finder unit;

FIG. 6B is a side elevation view showing a state of tele end of the conventional optical finder unit;

FIG. 7A is a cross section viewed from top showing a state of wide end of the conventional optical finder unit; and

FIG. 7B is a side elevation view showing a state of wide end of the conventional optical finder unit;

### DESCRIPTION OF THE PREFERRED EMBODIMENTS

Hereinafter, examples of the present invention will be described with reference to the accompanying drawings. Note that portions having the same functions as the above conventional technique will be denoted by the same reference signs so that detail description for them can be omitted.

### FIRST EXAMPLE

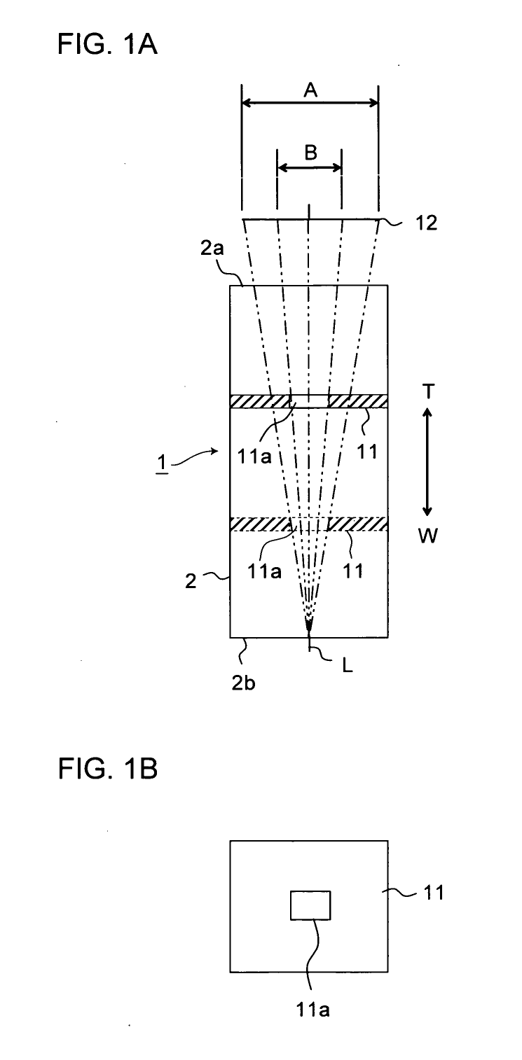

FIGS. 1A and 1B show schematically a structure of an optical finder unit according to a first example of the present invention. FIG. 1A is a cross section viewed from top, while FIG. 1B is a front elevation view. Note that, although a cross section viewed from side is omitted, it is similar to the cross section viewed from top. As shown in FIGS. 1A and 1B, the optical finder unit 1 according to this example includes a rectangular tubular finder housing 2 extending forward and backward and a plate 11 having a rectangular shape inside the finder housing 2. The plate 11 is arranged so that its edge portions are disposed along the inner surfaces of the finder housing 2, and in the center portion thereof there is provided a rectangular aperture 11a that defines a frame of a field of view.

Between a wide end position W shown by a broken line and a tele end position T shown by a full line, the plate 11 is moved along an optical axis L forward and back ward as indicated by an arrow in synchronization with zooming of an imaging lens (not shown), so that zooming of the optical finder is performed. With this arrangement, light from an object 12 enters the finder housing 2 through an opening portion 2a on the objective side, and the incident angle range thereof is restricted by the plate 11. More specifically, only light that passes through the aperture 11a can be observed at the opening portion 2b on the eyepiece side so as to form an image within the field of view. Thus, an actual imaging range is displayed in the optical finder when zooming is performed.

In FIG. 1A, a range of the field of view at the wide end position W is shown by a dimension line A, and a range of the field of view at the tele end position T is shown by a dimension line B. Although the object 12 is shown near to the optical finder unit 1 in FIG. 1A for convenience of illustrating the field of view, it should be a subject that is actually located considerably far from the same. This is similar to other examples below.

Concerning a mechanism for driving the plate 11, similarly to the conventional structure described above, a cam for zooming the optical finder may be provided to a barrel of the imaging lens so that the cam is engaged with the plate 11, and the cam may be driven in synchronization with a sliding barrel of the imaging lens. Alternatively, an additional driving source and a mechanism may be provided for driving the plate 11 in synchronization with zooming of the imaging lens. In addition to the structure shown in FIGS. 1A and 1B, it is also possible to provide an objective lens to the opening portion 2a on the objective side and an eyepiece lens to the opening portion 2b on the eyepiece side.

### SECOND EXAMPLE

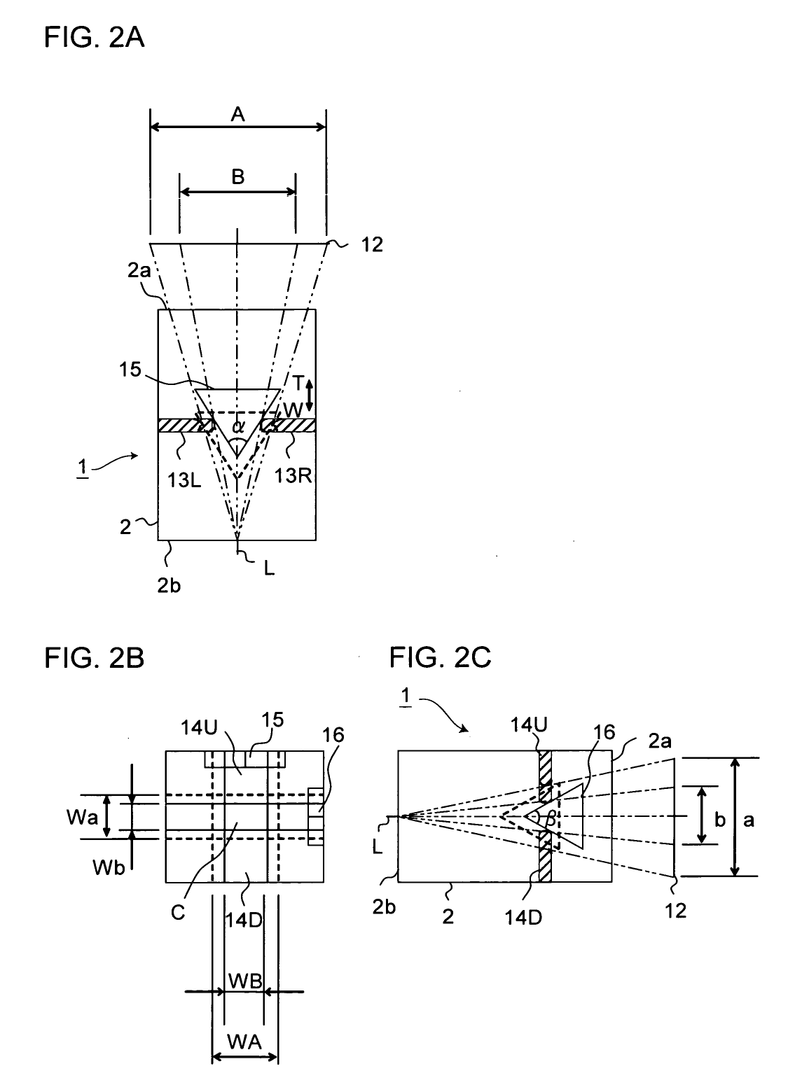

FIGS. 2A-2C show schematically a structure of an optical finder unit according to a second example of the present invention. FIG. 2A is a cross section viewed from top, FIG. 2B is a front elevation view, and FIG. 2C is a cross section viewed from side. As shown in FIGS. 2A-2C, the optical finder unit 1 according to this example includes a rectangular tubular finder housing 2 extending forward and backward, four aperture limiting members that are disposed inside the finder housing 2 and are pressed inward from each of the upper, the lower, the left, and the right sides. In FIGS. 2A-2C, the left and the right aperture limiting members are denoted by 13L and 13R respectively, while the upper and the lower aperture limiting members are denoted by 14U and 14D respectively.

In addition, on the ceiling face of the finder housing 2, there is provided a plate-like aperture adjusting member 15 having a triangular shape viewed from top between the left and the right aperture limiting members 13L and 13R. More specifically, two oblique side portions of the triangle of the aperture adjusting member 15 are sandwiched between inner edge portions of the two aperture limiting members 13L and 13R that are pressed inward, so that a width of the aperture between the aperture limiting members 13L and 13R is restricted.

When, in synchronization with zooming of the imaging lens (not shown), the aperture adjusting member 15 is moved forward and backward along the optical axis L as shown by an arrow between the wide end position W shown by the broken line and the tele end position T shown by the full line. As a result, a width of the aperture between the aperture limiting members 13L and 13R is changed so that zooming of the optical finder is performed. As understood from FIG. 2A, a width of the aperture between the aperture limiting members 13L and 13R becomes large when the aperture adjusting member 15 is moved to the wide end position W shown by the broken line, while it becomes small when the aperture adjusting member 15 is moved to the tele end position T shown by the full line.

In addition, a value of a vertex angle α of the aperture adjusting member 15 may be changed, so that a rate of change in the width of the aperture to a stroke of the aperture adjusting member 15 can be adjusted. Although the aperture adjusting member 15 is disposed on the ceiling face of the finder housing 2 in FIG. 2B, it is also possible to dispose the aperture adjusting member 15 on the bottom face of the finder housing 2. Alternatively, it is possible to dispose it on each of the ceiling face and the bottom face.

Similarly to the ceiling face of the finder housing 2, a plate-like aperture adjusting member 16 having a triangular shape is also disposed on a right inner face and is sandwiched between the upper and the lower aperture limiting members 14U and 14D. More specifically, two oblique side portions of the triangle of the aperture adjusting member 16 are sandwiched between inner edge portions of the two aperture limiting members 14U and 14D that are pressed inward, so that a width of the aperture between the aperture limiting members 14U and 14D is restricted.

Then, in synchronization with zooming of the imaging lens (not shown), the aperture adjusting member 16 is moved forward and backward along the optical axis L as shown by the arrow between the wide end position W shown by the broken line and the tele end position T shown by the full line. As a result, a width of the aperture between the aperture limiting members 14U and 14D is changed so that zooming of the optical finder is performed. As understood from FIG. 2C, a width of the aperture between the aperture limiting members 14U and 14D becomes large when the aperture adjusting member 16 is moved to the wide end position W shown by the broken line, while it becomes small when the aperture adjusting member 16 is moved to the tele end position T shown by the full line.

In addition, a value of a vertex angle β of the aperture adjusting member 16 may be changed, so that a rate of change in the width of the aperture to a stroke of the aperture adjusting member 16 can be adjusted. Although the aperture adjusting member 16 is disposed on the right inner face of the finder housing 2 in FIG. 2B, it is also possible to dispose the aperture adjusting member 16 on the left inner face of the finder housing 2. Alternatively, it is possible to dispose it on each of the right and the left inner faces.

Light from the object 12 enters the finder housing 2 through the opening portion 2a on the objective side, but the incident angle range thereof is restricted by the aperture limiting members 13L, 13R, 14U, and 14D. Only light that passes through the aperture C can be observed at the opening portion 2b on the eyepiece side to be an image within the field of view. Thus, an actual imaging range is displayed in the optical finder when zooming is performed. In FIGS. 2A and 2C, ranges of the field of view when the aperture adjusting member 16 is on the wide end position W are indicated by the dimension lines A and a respectively, while ranges of the field of view when the aperture adjusting member 16 is on the tele end position T are indicated by the dimension lines B and b. In addition, the widths of the aperture at the wide end position W are indicated by dimension lines WA and Wa, while the widths of the aperture at the tele end position T are indicated by dimension lines WB and Wb in FIG. 2B. In addition to the structure shown in FIGS. 2A-2C, it is also possible to provide an objective lens to the opening portion 2a on the objective side and an eyepiece lens to the opening portion 2b on the eyepiece side.

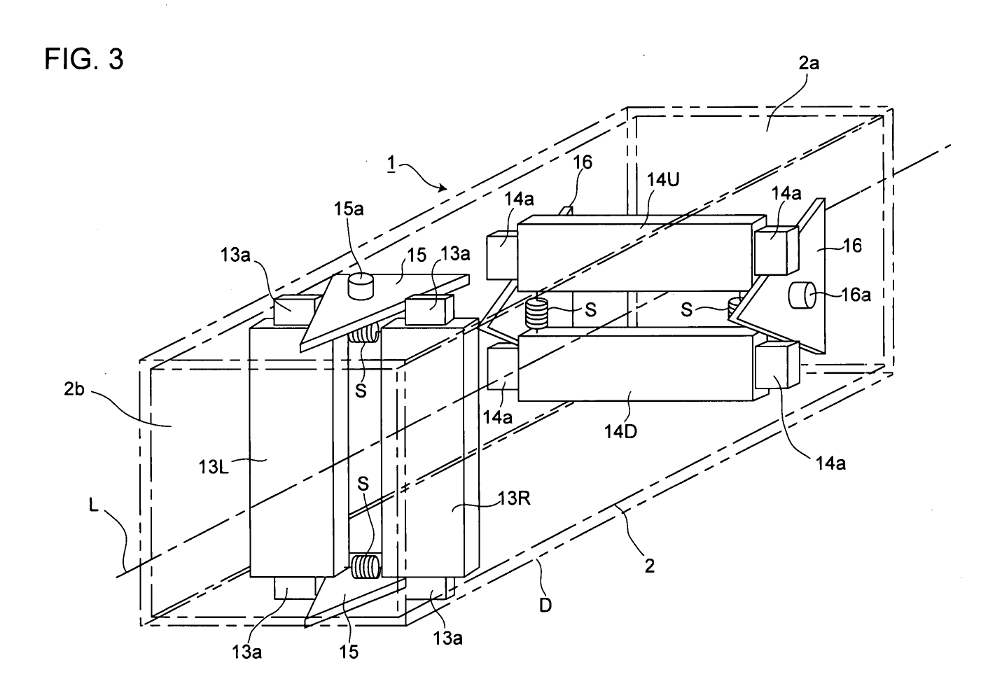

FIG. 3 is a perspective view showing schematically an example of a concrete structure of the optical finder unit according to this example. FIG. 3 shows the inside of the finder housing as a see-through view. As shown in FIG. 3, there is disposed a pair of the left and the right aperture limiting members 13L and 13R close to the eyepiece side of the finder housing 2 shown by a dashed dotted line. Each of the aperture limiting members 13L and 13R is provided with cam plates 13a at the upper and the lower end faces. The cam plates 13a can slide laterally on the ceiling face and the bottom face of the finder housing 2. In addition, a pair of extension coil springs S is provided between the aperture limiting members 13L and 13R at the upper and the lower end portions, so that the aperture limiting members 13L and 13R are linked to each other and pressed inward.

In addition, the plate-like aperture adjusting members 15 having a triangular shape are disposed between the cam plates 13a of the aperture limiting members 13L and 13R on the ceiling face and the bottom face of the finder housing 2. The oblique side portions of the triangle of the aperture adjusting member 15 are sandwiched between the inner edge portions of the cam plates 13a of the aperture limiting members 13L and 13R that are pressed by the extension coil spring S, so that a width of the aperture between the aperture limiting members 13L and 13R can be restricted.

In synchronization with zooming of the imaging lens between the wide end and the tele end, the aperture adjusting member 15 is moved forward and backward along the optical axis L by a follower pin 15a that is provided to the surface thereof. As a result, a width of the aperture between the aperture limiting members 13L and 13R is changed so that zooming of the optical finder is performed.

A pair of the upper and the lower aperture limiting members 14U and 14D is disposed near the objective side of the finder housing 2. Each of the left and the right end faces of each of the aperture limiting members 14U and 14D is provided with a cam plate 14a, which can slide upward and downward on the left and the right inner faces of the finder housing 2. Furthermore, an extension coil spring S is disposed between the aperture limiting members 14U and 14D at the left as well as at the right end portions, so that the aperture limiting members 14U and 14D are linked to each other and pressed inward.

In addition, the plate-like aperture adjusting members 16 having a triangular shape are disposed between the cam plates 14a of the aperture limiting members 14U and 14D on the left and the right inner faces of the finder housing 2. The oblique side portions of the triangle of the aperture adjusting member 16 are sandwiched between the inner edge portions of the cam plates 14a of the aperture limiting members 14U and 14D that are pressed by the extension coil spring S, so that a width of the aperture between the aperture limiting members 14U and 14D can be restricted.

In synchronization with zooming of the imaging lens (not shown) between the wide end and the tele end, the aperture adjusting member 16 is moved forward and backward along the optical axis L by a follower pin 16a that is provided to the surface thereof. As a result, a width of the aperture between the aperture limiting members 14U and 14D is changed so that zooming of the optical finder is performed.

Concerning a method for driving the aperture adjusting members 15 and 16 in the direction along the optical axis L, there is provided a driving barrel D (shown by dashed and double dotted line in FIG. 3) that engages the outer face of the finder housing 2 in a slidable manner, for example. The driving barrel D may be moved forward and backward along the optical axis L in synchronization with zooming of the imaging lens (not shown). Each of the follower pins 15a and 16a described above may protrude through the finder housing 2 so as to be engaged with the driving barrel D. Thus, the aperture adjusting members 15 and 16 can move forward and backward along the optical axis L together with the driving barrel D.

### THIRD EXAMPLE

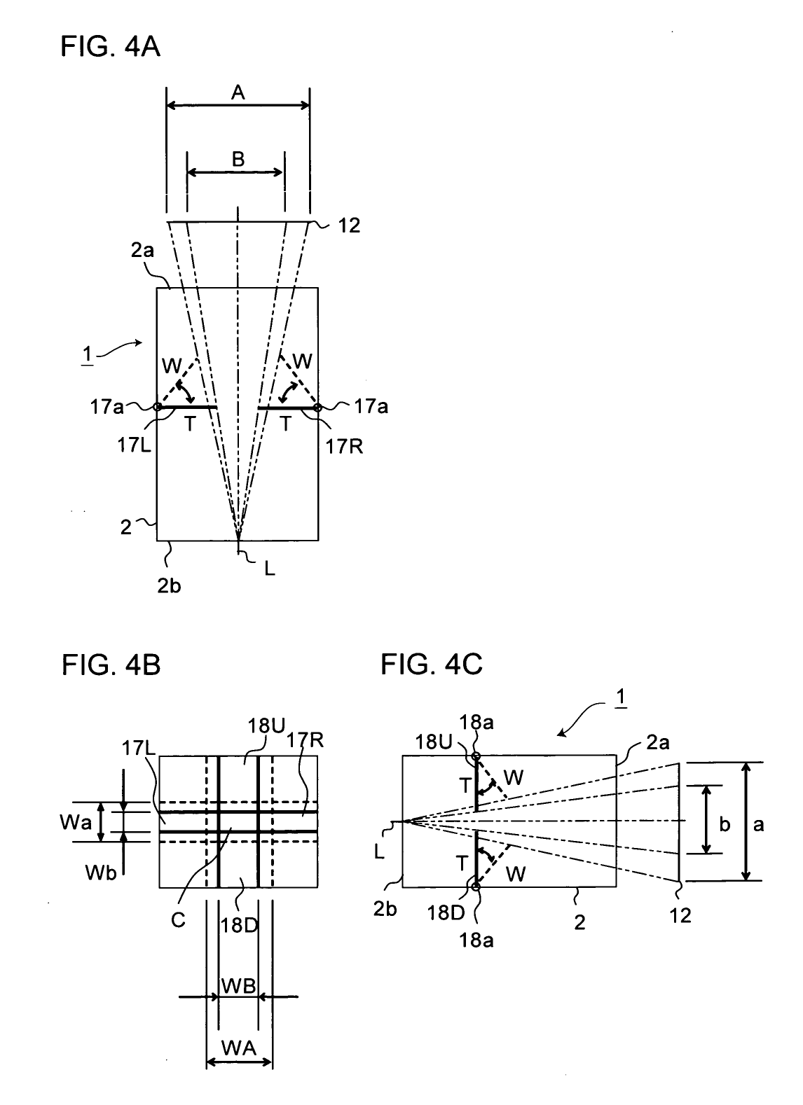

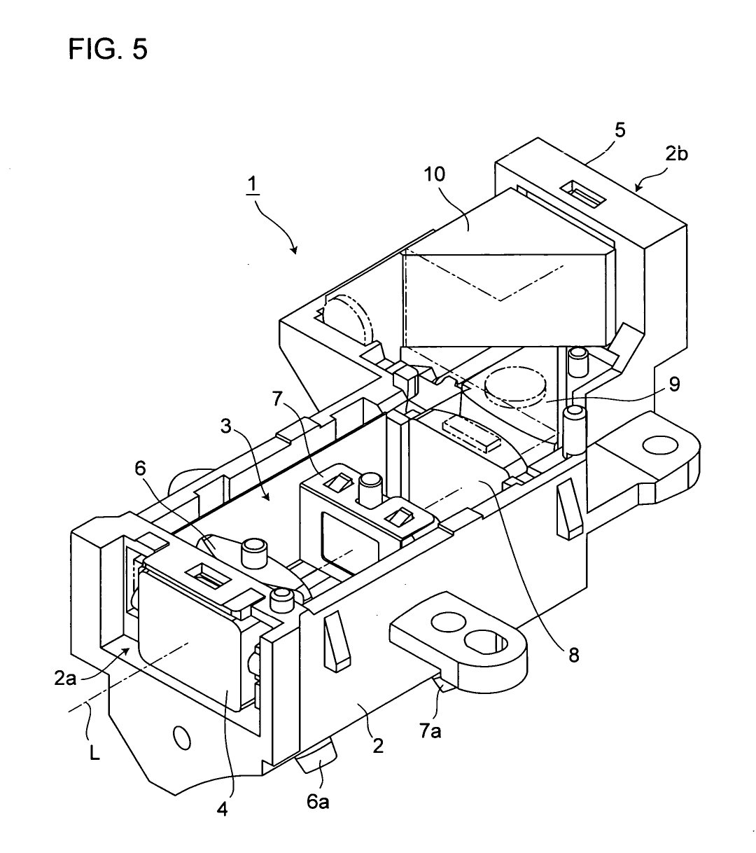

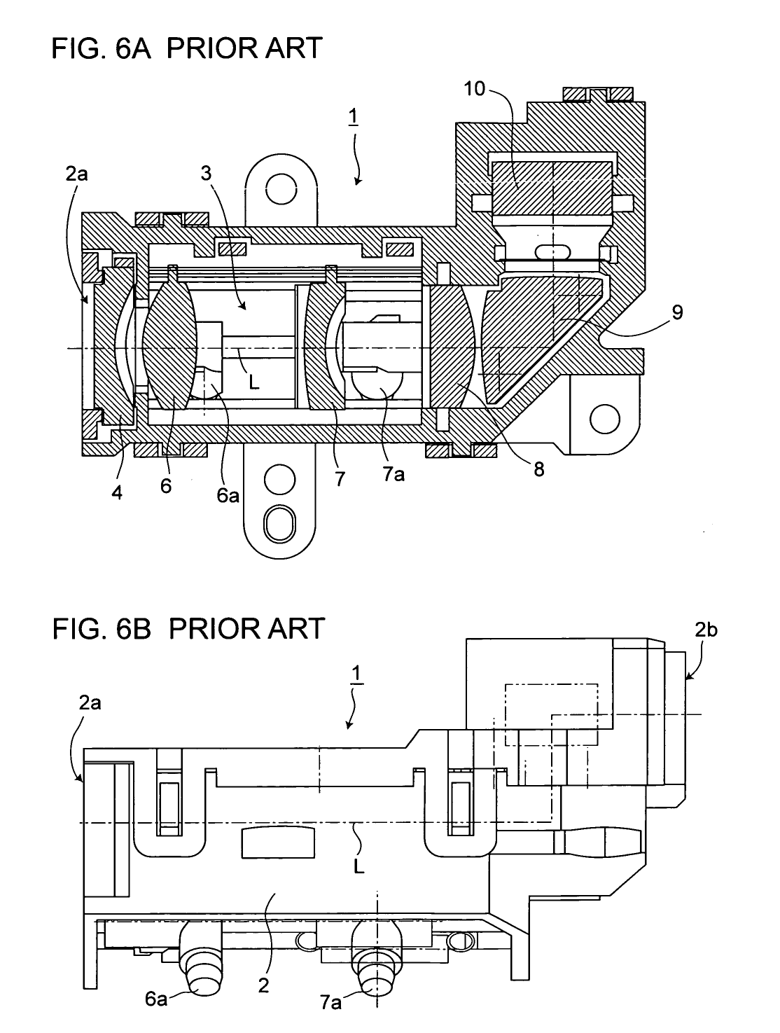

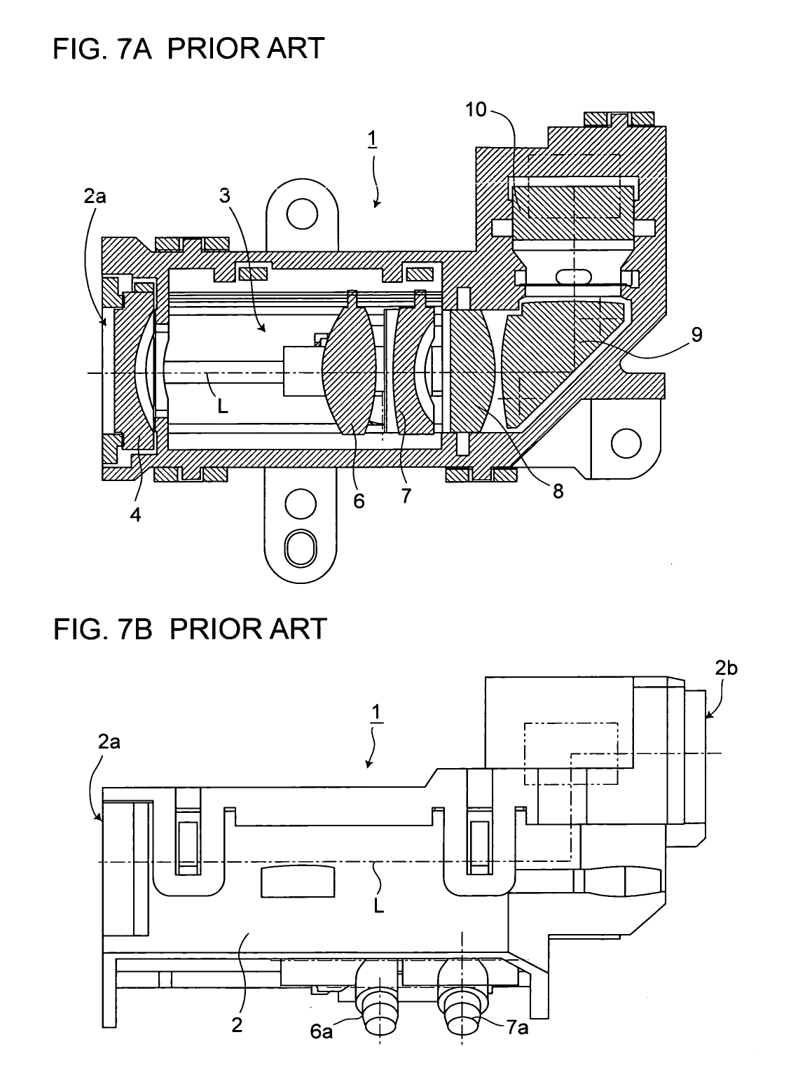

FIGS. 4A-4C show schematically a structure of an optical finder unit according to a third example of the present invention. FIG. 4A is a cross section viewed from top, FIG. 4B is a front elevation view, and FIG. 4C is a cross section viewed from side. As shown in FIGS. 4A-4C, the optical finder unit 1 of this example includes a rectangular tubular finder housing 2 extending forward and backward and four door members that are rotationally pivoted on the left, the right, the upper, and the lower inner surfaces of the finder housing 2 respectively. In FIGS. 4A-4C, the left and the right door members are denoted by 17L and 17R respectively, while the upper and the lower door members are denoted by 18U and 18D respectively.

In synchronization with zooming of an imaging lens (not shown), each of the door members 17L, 17R, 18U, and 18D rotates within the range between the wide end position W shown by a broken line and the tele end position T shown by a full line, so that zooming of the optical finder is performed. More specifically, each of the door members 17L and 17R rotates as shown by an arrow around a rotational axis 17a that is provided to the right and the left inner surfaces of the finder housing 2 as shown in FIG. 4A. Thus, a width of the aperture between the door members 17L and 17R is changed in the horizontal direction. In addition, each of the door members 18U and 18D rotates as shown by an arrow around a rotational axis 18a that is provided to the upper and the lower inner surfaces of the finder housing 2 as shown in FIG. 4C. Thus, a width of the aperture between the door members 18U and 18D is changed in the vertical direction.

Light from the object 12 enters the finder housing 2 through the opening portion 2a on the objective side, but the incident angle range thereof is restricted by the door members 17L, 17R, 18U, and 18D. Only light that passes through the aperture C can be observed at the opening portion 2b on the eyepiece side to be an image within the field of view. Thus, an actual imaging range is displayed in the optical finder when zooming is performed. In FIGS. 4A and 4B, ranges of the field of view when the door members 17L, 17R, 18U, and 18D are on the wide end position W are indicated by the dimension lines A and a respectively, while ranges of the field of view when the door members 17L, 17R, 18U, and 18D are on the tele end position T are indicated by the dimension lines B and b. Furthermore, in FIG. 4B, the widths of the aperture at the wide end position W are indicated by the dimension lines WA and Wa, while the widths of the aperture at the tele end position T are indicated by the dimension lines WB and Wb. In addition to the structure shown in FIGS. 4A-4C, it is also possible to provide an objective lens to the opening portion 2a on the objective side and an eyepiece lens to the opening portion 2b on the eyepiece side.

What is claimed is:

1. An optical finder of a camera having a variable field of view that changes in synchronization with zooming of an imaging lens, the optical finder comprising:
a tubular finder housing having opening portions on an objective side thereof and an opening portion on an eyepiece side thereof; and
a field of view limiting member for limiting an aperture corresponding to the field of view from the opening portion on the eyepiece side by protruding from an inner face of the finder housing,
wherein the field of view corresponding to the aperture is increased or decreased in synchronization with zooming of the imaging lens.

2. The optical finder according to claim 1,
wherein the field of view limiting member is a plate with an aperture arranged in a center portion thereof for determining the field of view, and the plate moves along an optical axis in synchronization with zooming of the imaging lens so that the field of view corresponding to the aperture is increased or decreased.

3. The optical finder according to claim 1,
wherein the field of view limiting member comprises four aperture limiting members that are pressed inward from upper, lower, left, and right inner faces of the finder housing and aperture adjusting members having oblique side portions that are sandwiched between a pair of the upper and the lower aperture limiting members and between a pair of the left and the right aperture limiting members respectively, and
the aperture adjusting members are moved along an optical axis in synchronization with zooming of the imaging lens so that the field of view is increased or decreased corresponding to a width of the aperture between the pair of the upper and the lower aperture limiting members and a width of the aperture between the pair of the left and the right aperture limiting members.

4. The optical finder according to claim 1,
wherein the field of view limiting member comprises four door members that are rotationally pivoted around rotational axes on left, right, upper, and lower inner surfaces of the finder housing respectively, and
the four door members rotate in synchronization with zooming of the imaging lens so that the field of view is increased or decreased corresponding to a width of the aperture between the pair of the upper and the lower door members and a width of the aperture between the pair of the left and the right door members.
